(19) United States
(12) Patent Application Publication
(10) Pub. No.: US 2012/0297395 A1
(43) Pub. Date: Nov. 22, 2012

(54) SCALABLE WORK LOAD MANAGEMENT ON MULTI-CORE COMPUTER SYSTEMS

(75) Inventors: Benoit Marchand, (US); Xinliang Zhou, Brossard (CA)

(73) Assignee: EXLUDUS INC., Montreal (CA)

(21) Appl. No.: 13/453,099

(22) Filed: Apr. 23, 2012

Related U.S. Application Data
(63) Continuation-in-part of application No. 12/543,443, filed on Aug. 18, 2009, now abandoned.
(60) Provisional application No. 61/189,358, filed on Aug. 18, 2008.

(51) Int. Cl. G06F 9/50

(52) U.S. Cl. 718/104

(57) ABSTRACT

A system and method for managing the processing of work units being processed on a computer system having shared resources e.g. multiple processing cores, memory, bandwidth, etc. The system comprises a job scheduler for scheduling access to the shared resources for the work units, and an event trap for capturing resource related allocation events. The event trap is adapted to dynamically adjust the amount of availability associated with each shared resource identified by the resource related allocation event. The allocation event may define a resource release or a resource request. The event trap may increase the amount of availability for allocation events defining a resource release, and decrement the amount of availability for allocation events defining a resource request. The job scheduler allocates resources to the work units using a real time amount of availability of the shared resources in order to maximize a consumption of the shared resources.

### CROSS-REFERENCE TO RELATED APPLICATIONS

This application is filed under 37 CFR 1.53(b) as a continuation-in-part application. This application claims priority under 35 USC §120 of U.S. patent application Ser. No. 12/543,443 filed on Aug. 18, 2009 which claims priority from U.S. provisional patent application No. 61/189,358 filed Aug. 18, 2008 and entitled “Method for Scalable Work Load Management on Multi-Core Computer Systems,” the disclosures of both applications are incorporated herein by reference in their entirety.

### BACKGROUND

(a) Field

The subject matter disclosed generally relates to work load management. More specifically the subject matter relates to dynamic resource allocation on computer systems that make use of multi-core processors.

(b) Related Prior Art

Amdahl's law is a model for the relationship between the expected speedup of parallelized implementations of an algorithm relative to the serial algorithm, under the assumption that the problem size remains the same when parallelized. The law is concerned with the speedup achievable from an improvement to a computation that affects a proportion P of that computation where the improvement has a speedup of S. Amdahl's law states that the overall speedup of applying the improvement is 1/((1−P)+P/S).

Assuming that the run time of an old computation was 1 for some unit of time. The run time of the new computation will be the length of time the unimproved fraction takes, which is (1−P), plus the length of time the improved fraction takes. The length of time for the improved part of the computation is the length of the improved part's former run time divided by the speedup. Thereby, the length of time of the improved part would be (P/S). The final speedup is computed by dividing the old run time by the new run time as formula reflected above.

In the case of parallelization, Amdahl's law states that if P is the proportion of a program that can be made parallel (i.e., benefit from parallelization) and (1−P) is the proportion that cannot be parallelized (i.e., remains serial), then the maximum speed up that can be achieved by using N processors is: 1/((1−P)+P/N)

In the limit, as N tends to infinity, the maximum speedup tends to 1/(1−P). In practice, performance to price ratio falls rapidly as N is increased once there is even a small component of (1−P). For example, if P is 90%, then (1−P) is 10% and the problem can be sped up by a maximum of a factor of 10 no matter how large the value of N used.

FIG. 1 is a graphical representation illustrating the effect of Amdahl's law on the processing performance as the number of processing cores increases. As shown in FIG. 1, the additional performance of the ensemble of such processing elements (e.g., processing cores and/or processing machines) asymptotically tends to a limit. Whereby, adding additional processing elements results in asymptotically less benefit to the processing of the algorithm in use. This effect is universal and is related to the ratio between the serial and parallel components of the algorithm. While the actual rate of convergence of the performance curve to the asymptote, and the value of the asymptote itself, is related to the proportion of serialization in the algorithm, even highly parallel algorithms converge after a small number of processing elements.

In this context, it is noted that at a very basic level, there is the need to schedule a stream of work units (often referred to as jobs) for execution on a central processing unit and to then manage the execution of the jobs in an orderly manner with some goal in mind. Recognizing that any particular job may not complete for some reason, a management scheme would require enhancements that allow it to deal with exceptions to the simple process of ordering one job to execute when its predecessor completes. The management scheme may, for example, detect an endlessly repeating loop in a running job and terminate execution of that job so that the next job in the input queue can be dispatched.

The work load manager components of a modern operating system generally implements a broad range of features that provide for sophisticated management of the work units in execution on a central processing unit. The allocation of resources needed to enable execution of the instructions of a work unit is scheduled in time and quantity of the resource based on availability. A job scheduler will be designed to achieve some goal, such as the fair or equitable sharing of resources amongst a stream of competing work units, the implementation of priority based scheduling to deliver preference to some jobs over others or such other designs that implement real time responsiveness or deadline scheduling to ensure that specified jobs complete within specified time periods.

In order to make an allocation of the resources needed to dispatch a job, the job scheduler must know the resource requirements of a job and the availability of resources on the central processing unit at the moment of job dispatch. A sampling scheme can typically be used to make such a comparison whereby the job scheduler can sample the resource status on the computer system, then determine if the resource requirements of a job represents a proper subset of the available resources. If so, the job scheduler can make an allocation and dispatch the jobs. Otherwise, the job must be held pending the availability of inadequate resource elements.

FIG. 2 illustrates work load scheduling method 200 for a conventional single-core central processing unit. The operating system of a computer system arranges for the periodic generation of scheduling events, typically by using a clock to interrupt the running state 210 of the computer system. The clock interrupt may also initiate a sequence of processing actions that first queries or samples the state of system resource utilization 220, reads a scheduling policy 230 and allocates resources to work units in a request queue 240, schedules the dispatch of work units 250, and then resumes the running state of the computer system 260.

In the context of a single core central processing unit, a sampling methodology may operate as a sufficient and effective method of determining a resource availability profile. In the context of a multi-core computer system, however, using such prior art methodologies results in a multiplication of the sampling operation over the number of processor cores. Each of these elements must be individually sampled to estimate the global state of the resource consumption or, consequently, the resource availability. In the general context of this approach, all of the processor cores of the central processing unit would have to be interrupted and held inactive if a completely consistent survey of the state of resources on the computer system is to be obtained.

FIG. 3 illustrates a conventional sample-based scheduling method 300 on a multi-core processor with N processor cores. Each of N processor cores is interrupted by a clock in step 270 and subsequently sampled in step 272. An allocation exercise is carried out in step 274 based on a system scheduling policy whereby N schedules are developed for the dispatching of the work units 276. The N running states are finally resumed in step 278. A serialization issue (as discussed in further detail below) arises because all of the processor cores are held in the interrupted state (step 270) until a consistent view of resource consumption is determined and appropriate dispatching schedules for work units can be constructed and the processor core states resumed (step 278).

As the number of processor cores grows, so does the sampling rate. This growth is inevitable because the individual processor cores are all executing independent and asynchronous tasks, which can change the resource consumption profile at any time. In this scenario, as the number of processor cores increases, the sampling rate necessarily must increase to ensure that resource consumption profiles are up to date. Ultimately, the sampling activity will come to dominate the scheduling activity and the overall efficiency of the computer system suffers, which may sometimes be characterized as suffering from the law of diminishing returns.

An additional issue with the sampling approach is that as the frequency of sampling increases, the error of the sampled state of the computer system likewise increases. This increase in error is due to the fact that each sample of a core of the ensemble of processor cores has an inherent error due to the finite time needed to carry out the sampling operation. Over the ensemble, the aggregate error is multiplicative of the individual errors. By increasing the number of processor cores, the utility of the aggregated sample tends towards zero.

As referenced above, in the context of the parallelization of an algorithm, sampling based approaches introduce a single point of serialization into a scheduling algorithm. A consistent view of resource availability depends on obtaining the state of resource consumption on each of a plurality of processor cores. Since each processor core will generally be asynchronously executing an independent work unit, a sampling design imposes a point of serialization if the global resource state is to be known. This serialization occurs at the point that the states of the processor cores are interrupted (step 270 in FIG. 3) and held in interrupt until the sampling activity is completed (step 278). Further, the resources in use on a multi-core processor are shared by the independent processor cores. Sharing imposes the serialization effect of sampling approaches. Thus, in order to obtain a consistent sampled view, the resource consumption profile of each of the tasks sharing the system resources must remain static during the sampling.

Therefore, there is a need for eliminating/reducing the effects of Amdahl's Law in the context of multi-core processor technologies, which otherwise limits the ability to scale up the benefits of using multi-core processor technologies congruent with the number of additional processor cores and/or processing units being deployed.

### SUMMARY

The present embodiments eliminate the effect of Amdahl's Law with respect to the allocation of shared resources on multi-core processor technologies, whereby the benefits of using multi-core processor technologies with an increased number of processor cores or processing units may be enjoyed.

Embodiments of the present invention may be implemented in a network of computers with a plurality of computational nodes, which may further implement multi-core processing units.

According to an embodiment, there is provided a method for managing processing of work units on a computer system having shared resources, the method comprising: gathering a list of the shared resources in a global resource table, the global resource table indicating an amount of availability for each shared resource; capturing an allocation event having associated therewith an identification of a shared resource and a value indicating an amount of resource for the identified shared resource; dynamically adjusting the amount of availability of the identified shared resource based on the value associated with the allocation event for that specific shared resource; and allocating available resources to the work units which are pending based on a current amount of availability of the shared resources in order to maximize a consumption of the shared resources.

According to another embodiment, the dynamically adjusting comprises incrementing the amount of availability of the identified shared resource by the amount of resource indicated by the value for allocation events defining a resource release.

According to a further embodiment, the dynamically adjusting comprises decrementing the amount of availability of the identified shared resource by the amount of resource indicated by the value for allocation events defining a resource request.

According to yet another embodiment, the capturing comprises implementing an event trap between a system call interface of the computer system and the work units, the event trap for capturing the allocation event.

According to another embodiment, the method further comprises setting, upon initialization of the computer system, the amount of availability for each shared resource to a value that represents 100 percent of capacity of the shared resource.

According to a further embodiment, the dynamically adjusting comprises updating the amount of availability of the shared resources, in real time.

According to yet another embodiment, wherein the amount of availability for each shared resource and the amount of resource for the identified shared resource comprises at least one of quantity and time.

According to another embodiment, there is provided a non-transitory computer readable medium having recorded thereon one or more programs for execution by a processor for implementing the method as described above.

According to another embodiment, there is provided a computer system including a processor and a memory having recorded thereon one or more programs for execution by the processor for managing processing of work units using shared resources, the computer system comprising: a job scheduler for scheduling access to the shared resources for the work units; an event trap for capturing a resource related allocation event, the event trap being adapted to dynamically adjust an amount of availability associated with each shared resource identified by the resource related allocation event based on a value associated with the resource related allocation event and indicating an amount of resource for the identified shared resource; wherein the job scheduler allocates resources to the work units using a real time amount of availability of the shared resources in order to maximize a consumption of the shared resources.

According to another embodiment, the event trap is provided between a system call interface of the computer system and the work units.

According to a further embodiment, the event trap is adapted to increment the amount of availability of the identified shared resource by the amount of resource indicated by the value for allocation events defining a resource release.

According to yet another embodiment, the event trap is adapted to decrement the amount of availability of the identified shared resource by the amount of resource indicated by the value for allocation events defining a resource request.

According to another embodiment, the shared resources include one or more processors, each having a plurality of processing cores.

According to a further embodiment, the shared resources include one or more of: multiple processing core of a heterogeneous nature, shared memory hierarchies with components of heterogeneous access characteristics, shared heterogeneous communications channels, and shared external devices.

According to yet another embodiment, the amount of availability for each shared resource is set to a value that represents 100 percent of capacity of the shared resource, upon initialization.

According to another embodiment, processing resources allocated for operation of the event trap are negligible compared to an overall system performance.

In the present document the following terms should be interpreted in accordance with the definitions provided below.

A processor core generally comprises an electronic circuit design that embodies the functionality to carry out computations and input/output activity based on a stored set of instructions (e.g., a computer program).

A multi-core processor comprises a central processing unit (CPU) of a computer system that embodies multiple asynchronous processing units (i.e., actual processors called “cores” or “processor cores”), each core is independently capable of processing one or more work units, such as a self contained process. A computer system which comprises a multi-core processor is referred to as a multi-core computer system. Processor cores in a multi-core processor may be linked together by a computer communication network embodied through shared access to common physical resources, such as in a current generation multi-core central processor computer chip or CPU, or the network may be embodied through the use of an external network communication facility to which each processor core has access.

A work unit comprises a sequence of one or more instructions or executable segments of an instruction for a CPU (i.e., one or more CPU instructions) that can be executed on a processor core as a manageable ‘chunk.’ A work unit encompasses the concept of a job, a process, a function, as well as a thread. A work load may be a partition of a larger block of instructions, as in a single process of a job that encompasses many processes. A work unit is bound in either time or space or both such that it may be managed as part of an ensemble of such work units. The work units are managed by a mechanism that can allocate resources needed to execute instructions that make up the work unit on the computer system and manage the execution of the instructions of the work unit by methods that include, but are not limited to, starting, stopping, suspending, and resuming execution.

A job scheduler may be implemented on the computer system as a software component as part of an operating system. The job scheduler is generally responsible for the scheduling of access to sufficient quantities of the shared resources of a computer system to a work unit so that it can successfully execute its instruction stream on the CPU of the computer system. A job scheduler implements functionality that comprises consideration of a list of resource requirements for a set of pending jobs, the examination of the resource availability profile in time for the associated processor core and the allocation of resources to jobs in a resource space that has the dimensions of resource quantity and time.

An allocatable resource of a computer facility comprises any computer resource that is necessary for the execution of work units on the computer facility and which can be shared amongst multiple work units. Examples of allocatable resources include, but are not limited to, central processor time, memory, input/output bandwidth, processor cores, and communications channel time.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a graphical representation illustrating the effect of Amdahl's law on the processing performance as the number of processing elements increases;

FIG. 2 is a flowchart which illustrates the conventional work load scheduling method for a single-core computing system;

FIG. 3 is a flowchart which illustrates a conventional sample-based scheduling method on a multi-core computer system with N processing cores;

FIG. 4 is a flowchart of an event handling in an accounting based method for allocating resources in a multi-core computer system, in accordance with an embodiment;

FIG. 5 illustrates an example of a computer system comprising an event trap layer, in accordance with an embodiment;

FIG. 5a illustrates an alternative configuration for providing the event trap layer in a computer system, in accordance with another embodiment;

FIG. 6 illustrates the computer system of FIG. 5 and details of the event trap layer;

FIG. 7 is a flowchart of a method for managing the processing of work units on a computer system having shared resources; and

FIG. 8 is a block diagram showing an embodiment of a computing environment in which embodiments of the present invention may be practiced.

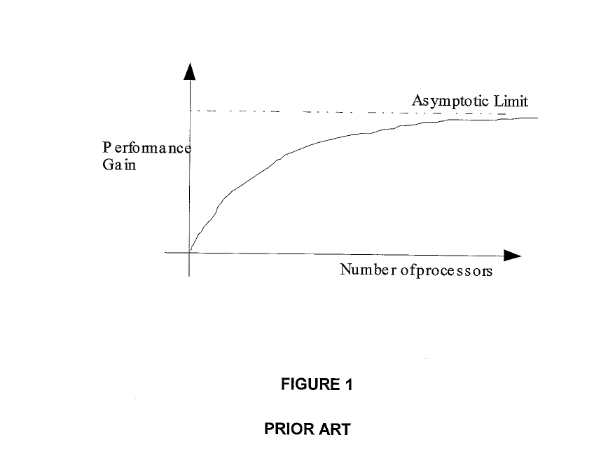

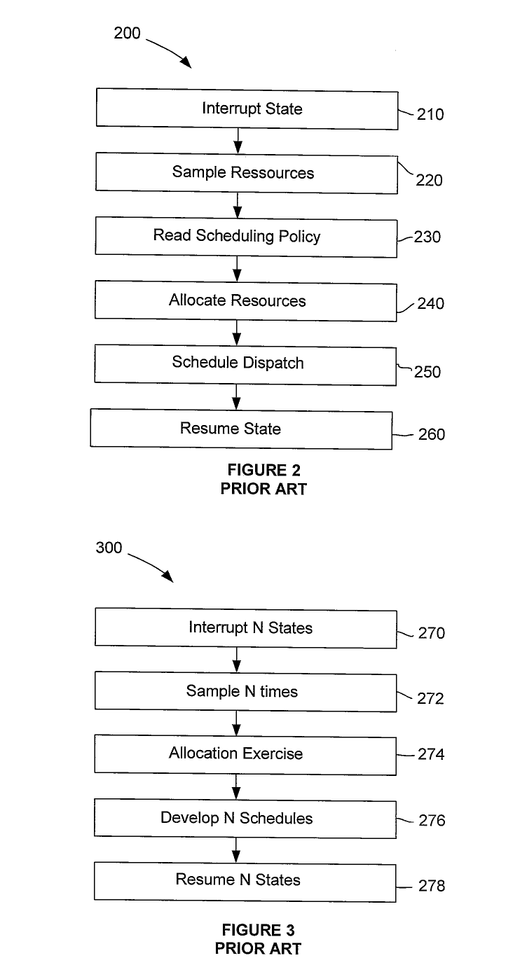

It will be noted that throughout the appended drawings, like features are identified by like reference numerals.

### DETAILED DESCRIPTION

Scheduling components found in prior art rely on a number of techniques to develop a resource availability profile that is distributed in time. Once the estimated resource availability profile is known, an allocation of the estimated available resources to jobs can be carried out according to various kinds of scheduling rules.

Embodiments of the present invention relate to the problem of the allocation of resources against a list of resource requirements at a particular instant in time. Specifically, embodiments of the present invention describe a mechanism for ensuring that the resource availability profile for a multi-core computer system is exact and current at the particular instant of a resource allocation event. In particular, the embodiments do not carry out job scheduling in a resource space that has a time dimension. The embodiments compare the current resource availability profile with the current list of pending resource requests and carry out an allocation that consumes the maximum amount of the available resources.

In an effort to minimize the effects of Amdahl's Law, embodiments of the present invention implement an alternative to prior art sampling based approaches by means of accounting. Through accounting, embodiments of the present invention propose a scheme where the consumption of computer resources is accounted for at the point of allocation, or release, to or from a specific work unit, or to or from the resource configuration of the processing facility. At each event affecting the resource availability profile of the processing facility, the resource availability balance is updated to reflect the change. The detrimental issues associated with sampling methods described above are avoided such that a current resource balance is available for use in allocation exercises.

A resource allocation event occurs uniquely when a computing resource is released by a work unit running on a computer system. The quantity of the released resource may be defined at any granularity suitable for the efficient management of resource allocation in the context of the embodiment of the invention. Examples include the release of a processor core, the release of a page of memory, the release of a communication channel or the release of a device. A device may be any form of real or virtual resource that may be shared between work units being processed on the computer system.

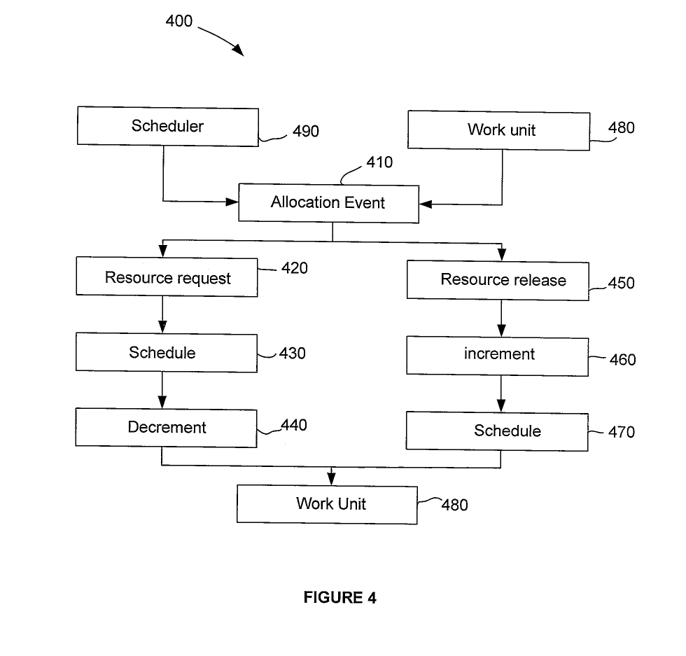

FIG. 4 illustrates an exemplary flowchart of an event handling in an accounting based method 400 for allocating resources in a multi-core computer system, in accordance with an embodiment. As shown in FIG. 4, the method 400 does not involve serialization of a global resource allocation algorithm as in the prior art. It should be noted that method 400 depicts what happens on a single processing element of the computer system when a resource allocation event occurs.

In the example of FIG. 4, a scheduler 490 or a work unit 480 such as a job, a process, a thread or any manageable quantity of work for a processing element, may initiate an allocation event 410 to modify its own resource consumption profile. In an embodiment, the allocations events may be considered as systems calls which may be trapped by an event trap as described herein below. Each allocation event 410 may indicate one or more resources and a value that indicates an amount for each resource indicated. Each resource may have a different measuring unit, for example, an allocation event may be associated with 4 MB of memory, 100 MHz of CPU cycles, 100 MB/s of bandwidth etc. In another embodiment, the resources may include the dimensions of units and class. For example, processor cores may be allocated in units of a class, where the units are cores, and the classes may be a type of processor, such as a signal processor, a vector processor, an I/O processor, or any of a number of types of dedicated purpose processors like a Wi-Fi radio, an accelerometer, a GPS radio, a pressure sensor, etc. In addition, the units may be fractional values of the resource, like a percentage in time of a processor core. In terms of units, typically memory is allocated in bytes, bandwidth in bytes per second, channels in whole or fractional units of a channel. Special purpose or dedicated purpose devices are allocated in time units, either whole or fractional parts of seconds.

As described above, the allocation event may be trapped by an event trap and routed according to its type and origin. The event trap may be implemented as a software layer, as will be described in further detail herein below. The allocation event 410 may either define a resource release 450 or a resource request 420.

In an embodiment, the event trap may create a global resource table that includes real time information about resource availability of each resource. The global resource table indicates for each resource the available amount (or quantity) that is unused and ready for allocation. For example, the global resource table may indicate that there is 400 MB of unused memory available for allocation.

In the case of a resource request 420, the resource request 420 may result in a schedule action 430 that decrements the resource availability for the specified resource by the specified amount (step 440). For resource release events 450, the resource availability is increased by the amount of the resource that is released (step 460). The resource release event 450 may then result in schedule action 470. In the context of a dynamically changing resource configuration for a computer system according to an embodiment, any change to resource configuration may also be considered during the accounting operation.

The resource allocation activity for each of the processors of the computer system is independent, asynchronous, and carried out in parallel without any serializing element in a scheduling algorithm. As a result, Amdahl's Law would not have any effect on the performance of the system as the number of resource elements grows, and the issue of a limited scalability in the computer is avoided.

In a non-limiting example of implementation, the amount of availability of each allocatable resource is set to 100 percent upon initialization. Any action by the allocation manager (e.g., at step 420 or 450) to allocate a resource is then accounted for against the global amount of availability for that resource by decrementing or incrementing the availability amount by the amount of the allocation (e.g., at step 440 or 460). Whenever a work unit such as an application releases a resource as might occur at step 450, either by terminating, or specifically releasing the resource, the global account for that resource is incremented by the quantity of the resource released.

Where a computer processing facility can be subject to dynamic changes to its resource configuration, either through the intended or unintended augmentation or reduction of its resource complement, the accounting method of the present embodiments may be used to update the resource availability profile at the point in time that the resource configuration change is recognized. Such recognition may occur as a result of information exchange between the operating system and the accounting mechanism described herein. Recognition may also be initiated through direct configuration actions by external agents, such as the operator of the computer processing facility.

The result of the accounting method is, at all times, a current account balance of all allocatable resources of the computer system. Work unit management, therefore, has available all of the information needed by a job scheduling process to effectively map resource requests to resource availability without the need for a sampling operation.

In an embodiment, the operation that maps resources to work units is initiated only at times where there is a change in the resource availability profile. If there is no change in resource availability, there is no need to reconsider the current allocation of resources against requests. When a change of resource availability occurs, either because a work unit acquired a quantity of resource, or because a work unit released a quantity of resource, a reallocation exercise is warranted.

A change in resource availability initiated by a process running on a core of a multi-core computer system itself initiates the update of the global resource accounting and carries out a reallocation operation of resources against resource availability using the updated global resource balance. This scheme is asynchronous across all of the cores of the processing system and is completely independent of other cores and other work units running on those cores. This scheme occurs on an as needed and just in time basis. As a result, the constraints of Amdahl's Law do not apply to the allocation algorithm and the design suffers no algorithm related scalability issues as the number of processing cores increases.

The present invention will be more readily understood by referring to the following examples which are given to illustrate the invention rather than to limit its scope.

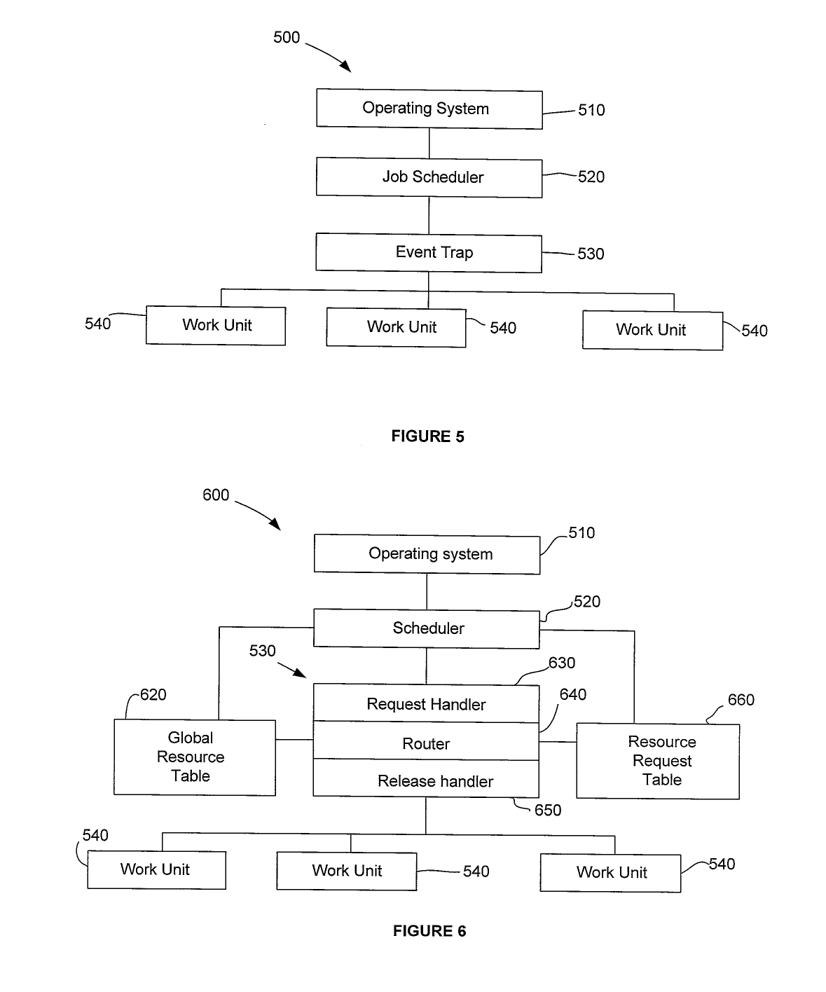

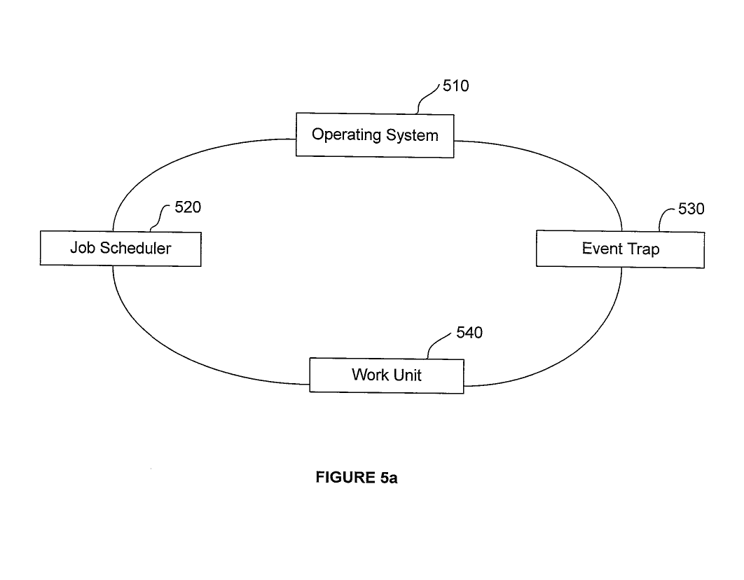

FIG. 5 illustrates an example of a computer system comprising an event trap layer, in accordance with an embodiment. In this example, the computer system comprises a multi-core processor, and a quantity of shared memory. The computer might also include various types of shared resources, such as multiple processing units of a heterogeneous nature, shared memory hierarchies with components of heterogeneous access characteristics, shared heterogeneous communications channels, and shared external devices. For the purposes of the present example, only processor cores and memory chunks are considered.

In terms of the allocation mechanism, the exemplary embodiment considers a processor comprising n processing cores which may be allocated in whole units. In the general case, a computer system may support partial allocation of processor cores using real or virtual bases. In the present example, shared memory is allocated in terms of memory pages which are blocks of memory of a specified size. A typical size for a memory page on a current generation computer is 4096 bytes, however the size of the memory page will be implementation specific and does not affect the generality of the embodiment of the invention.

As shown in FIG. 5, the computer system comprises an operating system 510, a job (or work unit) scheduler 520, an event trap layer 530 and any number of work units 540.

FIG. 6 illustrates the computer system of FIG. 5 and details of the event trap layer 530. The scheduler 520 is adapted to allocate resource requests from a list of pending work units 540 against a list of available processing resources provided in the global resource table 620 by distributing them in time. For instance, the operating system may schedule jobs for which insufficient memory is currently available for execution sometime in the future. The schedule for a particular work unit is derived from the current profile of the global resource table 620 of the computer system and information about pending work unit requests 660. At any given instant, the computer operating system will ideally match the pending work load to the resource availability of the system in a manner that makes maximum use of the available resources.

Operating system software typical of prior art becomes aware of the resource availability profile of the computer system by periodically sampling the state of running work units. By contrast, the present embodiments implement an event trap 530 between the operating system 510 and the work units 540 as shown in FIG. 5. Alternatively, the event trap 530 may be provided in a loop with the operating system 510, the scheduler 520 and the work unit 540, as shown in FIG. 5a. In this scenario, allocation events defining a resource request proceed counter-clockwise from the work unit 540 to the scheduler 520, to the operating system 510, to event trap 530 and again to the work unit 540. For a resource release, the path is clockwise. In any case, the event trap 530 may be introduced between the system call interface of the operating system 510 and the work units 540, such that all resource allocation and release calls initiated by the work units 540, or by the job scheduler components of the operating system 510 may be captured by the event trap 530. Whereby, it becomes possible to maintain a running account of the current state of resource consumption on the computer system in real time.

In an embodiment, a data structure which is also known as the global resource table 620 is constructed by the event trap 530 when the latter is initialized. The table 620 may contain an entry for each allocatable resource. An entry in the resource table 620 may be a data structure that comprises the current value of the available quantity of the shared resource. In a more general context, each entry in the global resource table may contain, in addition to the available resource value, an arbitrary number of additional attributes that classify or qualify the resource. These possible attributes are application dependent and do not affect the generality of the operation of the invention.

At initialization, all of the entries in the table 620 are set to a value that represents 100 percent of the allocatable resource value for that resource. In the example embodiment described here, the value for processor cores in this table 620 would be equal to the number of cores, and the value for the number of memory pages would be the total number of pages in the computer systems memory.

Other embodiments may include table entries that are more detailed and extensive, as in the case where the entry for processors may contain a number that represents either whole or fractional parts of virtual processing elements, along with class attributes that describe the characteristics of processor cores in terms of architecture, priority or reservation. Similarly, any other possible shared resource may have a table representation that is more elaborate than the simple example discussed here.

As discussed above, there could be two types of events that may affect the contents of the global resource availability table 620. In particular, the scheduler 520 may allocate a profile of resources to a work unit 540, or the work unit 540 may release some resources that it has acquired through a previous scheduler action.

In an embodiment, only the scheduler 520 may allocate resources, and such allocations are based on the current state of the global resource table 620 when the allocation request is received by the scheduler. Since all system calls related to resource changes are trapped by the event trap layer 530 that is a component of the current embodiment, whenever an event affecting resource allocation happens, the event trap software can and does update the global resource table 620.

A scheduler 520 driven event represents an allocation of resources, and decrements the relevant resource quantity in the table 620. A work unit driven event represents a release of resources currently being consumed by the work unit, and increments the relevant resource quantity in the global resource table 620.

As shown in FIG. 6, the event trap 530 comprises a request handler 630, a router 640, and a release handler 650. The router 640 determines the nature of the event. For request events initiated by the scheduler 520, the request handler 630 looks up the current resource value in the global resource table 620 and decrements it by the amount of the resource request. For work unit initiated request events, the router 640 passes the request, possibly after an application dependent modification of the request value, to the scheduler 520 for action. This latter action will typically result in a scheduler 520 initiated request event at some later time.

For release events, the router 640 increments the relevant entry in the global resource table 620 and forwards the request to the scheduler 520. In an embodiment, release events may originate with the scheduler 520 in the sense that a work unit 540 may be pre-empted, killed or otherwise managed by either the operating system 510 or the scheduler 520. These events are passed through the router 640, again with possible application related adjustment, but they do not result in changes to the global resource table 620.

In situations which are more complex than the one described in this example, the embodiments may carry out various kinds of manipulation of the resource request based on application specific requirements before passing them along to the operating system for scheduling action. In the present example, the requested resource amounts are passed unchanged to the operating system.

In an embodiment, the overhead of the use of the event trap layer 530 that forms part of the current invention is, in general, and on a per work unit basis, insignificant when compared to the resource consumption of the work units 540 themselves, and is a function of the number of work units being processed by the computer system. The upper bound on the overhead of the accounting system is limited by the number of work units that can run on the system and there allocation activity. Consequently, as long as the system can run a work unit, the resource allocation scheme will also run.

Accordingly, the event trap layer 530 allows for increasing the amount of processing time needed by the operating system to handle resource events. The increased time required by the event trap layer 530 is typically very small compared to the time required by the operating system to handle the resource event.

The accounting mechanism requires negligible processing time when compared to the alternative of scanning a work unit status table to determine the state of the work units and maintaining local resource profiles for each of the work units, and of the allocatable resources themselves. In particular, the polling mechanisms characteristic of commonly implemented scheduling schemes require not only a fixed period of sampling time, but also a scheme to lock the global resource table

Where resource scheduling is concerned, the operating system makes use of whatever scheduling system it has in place. The present embodiments allow for eliminating the need for polling off the work unit process list in order to update the global resource profile of the system. The purely asynchronous event driven nature of the present mechanism means that there is no asymptotic limit to the scalability of the allocation mechanisms when managing the quantity of shared resources.

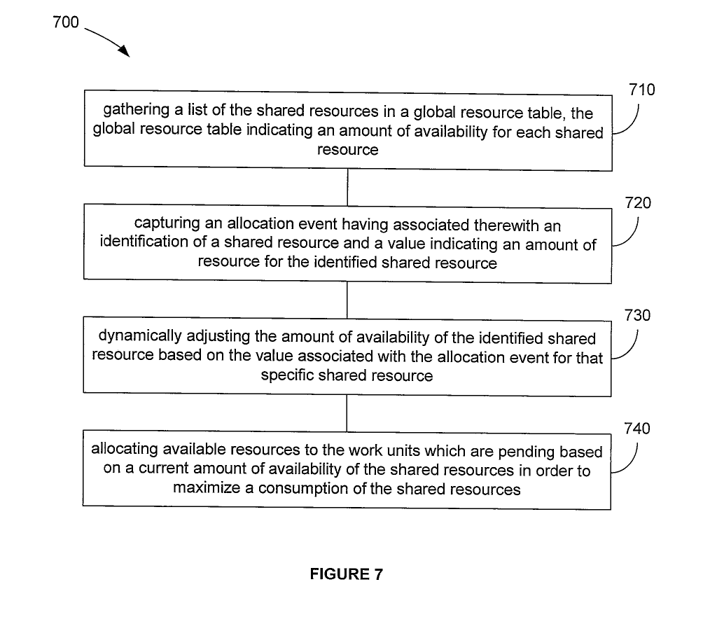

FIG. 7 is a flowchart of a method 700 for managing the processing of work units on a computer system having shared resources. At step 710 the method comprises gathering a list of the shared resources in a global resource table, the global resource table indicating an amount of availability for each shared resource. Step 720 comprises capturing an allocation event having associated therewith an identification of a shared resource and a value indicating an amount of resource for the identified shared resource. Step 730 comprises dynamically adjusting the amount of availability of the identified shared resource based on the value associated with the allocation event for that specific shared resource. Step 740 comprises allocating available resources to the work units which are pending based on a current amount of availability of the shared resources in order to maximize a consumption of the shared resources.

The accounting method implemented in the present embodiments does not suffer from the scalability limits of the sampling method of the prior art because there is no serialization due to the need to interrupting the running state of the system, in order to sample the resource profiles of the various components of the system to update the global resource allocation table. The scalability of the present system is then dependent on the computational requirements of the methods used to update the global resource table itself. Elements of the global resource table are entries that describe the quantity of any given resource that is currently available to an accuracy limited by the typically very small time needed to update the table values following resource release or allocation notifications. Since the resource table entries are values associated with distinct resource elements, such as a processor core, a quantity of memory, time on a channel, or some quantity of a virtual resource, the table entries are independent of each other, and operations on the global resource table are intrinsically atomic. This means that no serialization is present due to the need to lock the global resource table during updates.

As the size of the global resource table grows due to either the addition of more allocatable resources, or due to the addition of more virtual allocatable resources, the only impact on system performance is the computational load needed to perform table entry updates which, as discussed above is negligible. This load grows linearly with the number of allocatable resource elements, given the number of resource update events remains constant within the context of a particular work load. For any specific defined work unit, the number of resource allocation and release events remains constant and independent of the physical configuration of the computer system on which the work load is being run. For instance, a computer program will make the same number of memory allocation and release requests during its running time regardless of the computer on which it runs. Similarly for other allocatable resources, as long as the work load produced by the program does not change, the number of resource events will remain constant.

According to the present method, the performance cost for maintaining the inventory of allocatable resources grows linearly with the number of global resource table entries, and the relative size of the performance cost is very small compared to the resource cost of the work load components itself (substantially negligible). Therefore, presuming that the resources can be scaled without limit, the capacity of the underlying computer system in accordance with an embodiment of the present invention can also be scaled without limit in a strictly linear manner with the quantities of additional resources added to the system, unlike the case of a scheme subject to Amdahl's Law effects.

### Hardware and Operating Environment

Embodiments of the invention may be implemented/operated using a client machine. The client machine may in some embodiments be embodied in any one of the following computing devices: a computing workstation; a desktop computer; a tablet, a laptop or notebook computer; a server; a handheld computer; a mobile telephone; a portable telecommunication device; a media playing device; a gaming system; a mobile computing device; a device of the IPOD or IPAD family of devices manufactured by Apple Computer; any one of the PLAYSTATION family of devices manufactured by the Sony Corporation; any one of the Nintendo family of devices manufactured by Nintendo Co; any one of the XBOX family of devices manufactured by the Microsoft Corporation; or any other type and/or form of computing, telecommunications or media device that is capable of communication and that has sufficient processor power and memory capacity to perform the methods and systems described herein. In other embodiments the client machine can be a mobile device such as any one of the following mobile devices: a JAVA-enabled cellular telephone or personal digital assistant (PDA), such as the i55sr, i58sr, i85s, i88s, i90c, i95cl, or the im1100, all of which are manufactured by Motorola Corp; the 6035 or the 7135, manufactured by Kyocera; the i300 or i330, manufactured by Samsung Electronics Co., Ltd; the TREO 180, 270, 600, 650, 680, 700p, 700w, or 750 smart phone manufactured by Palm, Inc; any computing device that has different processors, operating systems, and input devices consistent with the device; or any other mobile computing device capable of performing the methods and systems described herein.

Still other embodiments of the client machine include a mobile client machine that can be any one of the following: any one series of Blackberry, Playbook or other handheld device manufactured by Research In Motion Limited; the iPhone manufactured by Apple Computer; Windows Phone 7, HTC, Sony Ericsson, any telephone or computing device running the Android operating system, or any handheld or smart phone; a Pocket PC; a Pocket PC Phone; or any other handheld mobile device supporting Microsoft Windows Mobile Software, etc.

The client machine may include a display and a touch-sensitive surface. It should be understood, however, that the computing device may also include one or more other physical user interface devices, such as a physical keyboard, a mouse and/or a joystick.

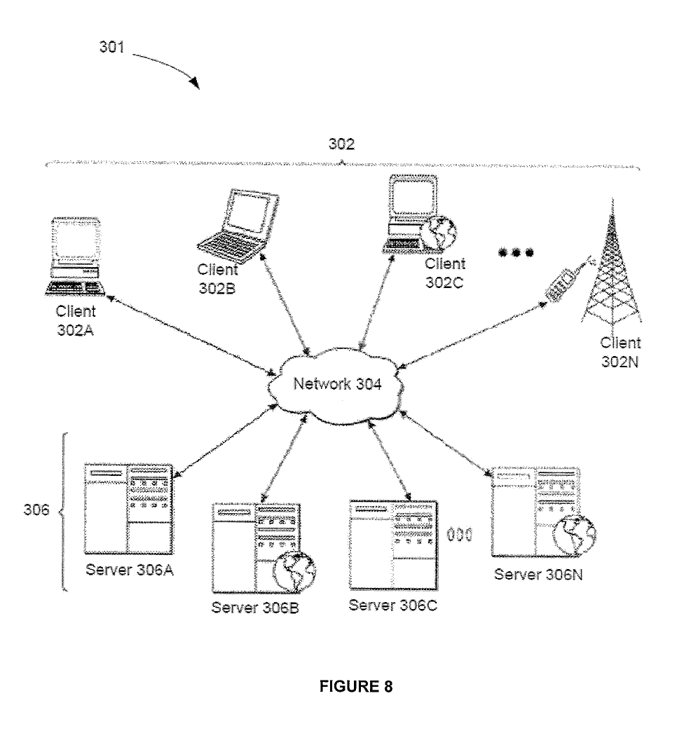

FIG. 8 illustrates an example of a computing environment 301 that includes one or more client machines 302A-302N in communication with servers 306A-306N, and a network 304 installed in between the client machines 302A-302N and the servers 306A-306N. In some embodiments, client machines 302A-302N may be referred to as a single client machine 302 or a single group of client machines 302, while servers may be referred to as a single server 306 or a single group of servers 306. One embodiment includes a single client machine 302 communicating with more than one server 306. Another embodiment includes a single server 306 communicating with more than one client machine 302, while another embodiment includes a single client machine 302 communicating with a single server 306.

The client machine 302 may in some embodiments execute, operate or otherwise provide an application that can be any one of the following: software; a program; executable instructions; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other type and/or form of executable instructions capable of executing on client machine 302. Still other embodiments may include a computing environment 301 with an application that is any of either server-based or remote-based, and an application that is executed on the server 306 on behalf of the client machine 302. The client machine 302 may include a network interface to interface to a Local Area Network (LAN), Wide Area Network (WAN) or the Internet through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above.

The computing environment 301 can in some embodiments include a server 306 or more than one server 306 configured to provide the functionality of any one of the following server types: a file server; an application server; a web server; a proxy server; an appliance; a network appliance; a gateway; an application gateway; a gateway server; a virtualization server; a deployment server; a SSL VPN server; a firewall; a web server; an application server or as a master application server; a server 306 configured to operate as an active direction; a server 306 configured to operate as application acceleration application that provides firewall functionality, application functionality, or load balancing functionality, or other type of computing machine configured to operate as a server 306. In some embodiments, a server 306 may include a remote authentication dial-in user service such that the server 306 is a RADIUS server.

The network 304 between the client machine 302 and the server 306 is a connection over which data is transferred between the client machine 302 and the server 306. Although the illustration in FIG. 8 depicts a network 304 connecting the client machines 302 to the servers 306, other embodiments include a computing environment 301 with client machines 302 installed on the same network as the servers 306. Other embodiments can include a computing environment 301 with a network 304 that can be any of the following: a local-area network (LAN); a metropolitan area network (MAN); a wide area network (WAN); a primary network comprised of multiple sub-networks located between the client machines 302 and the servers 306; a primary public network with a private sub-network; a primary private network with a public sub-network; or a primary private network with a private sub-network. Still further embodiments include a network 304 that can be any of the following network types: a point to point network; a broadcast network; a telecommunications network; a data communication network; a computer network; an ATM (Asynchronous Transfer Mode) network; a SONET (Synchronous Optical Network) network; a SDH (Synchronous Digital Hierarchy) network; a wireless network; a wireline network; a network 304 that includes a wireless link where the wireless link can be an infrared channel or satellite band; or any other network type able to transfer data from client machines 302 to servers 306 and vice versa to accomplish the methods and systems described herein. Network topology may differ within different embodiments, possible network topologies include: a bus network topology; a star network topology; a ring network topology; a repeater-based network topology; a tiered-star network topology; or any other network topology able transfer data from client machines 302 to servers 306, and vice versa, to accomplish the methods and systems described herein. Additional embodiments may include a network 304 of mobile telephone networks that use a protocol to communicate among mobile devices, where the protocol can be any one of the following: AMPS; TDMA; CDMA; GSM; GPRS UMTS; or any other protocol able to transmit data among mobile devices to accomplish the systems and methods described herein.

1. A method for managing processing of work units on a computer system having shared resources, the method comprising:
gathering a list of the shared resources in a global resource table, the global resource table indicating an amount of availability for each shared resource;
capturing an allocation event having associated therewith an identification of a shared resource and a value indicating an amount of resource for the identified shared resource;
dynamically adjusting the amount of availability of the identified shared resource based on the value associated with the allocation event for that specific shared resource; and
allocating available resources to the work units which are pending based on a current amount of availability of the shared resources in order to maximize a consumption of the shared resources.

2. The method of claim 1, wherein the dynamically adjusting comprises incrementing the amount of availability of the identified shared resource by the amount of resource indicated by the value for allocation events defining a resource release.

3. The method of claim 1, wherein the dynamically adjusting comprises decrementing the amount of availability of the identified shared resource by the amount of resource indicated by the value for allocation events defining a resource request.

4. The method of claim 1, wherein the capturing comprises implementing an event trap between a system call interface of the computer system and the work units, the event trap for capturing the allocation event.

5. The method of claim 1, further comprising setting, upon initialization of the computer system, the amount of availability for each shared resource to a value that represents 100 percent of capacity of the shared resource.

6. The method as in claim 1, wherein the dynamically adjusting comprises updating the amount of availability of the shared resources, in real time.

7. The method of claim 1, wherein the amount of availability for each shared resource and the amount of resource for the identified shared resource comprises at least one of quantity and time.

8. A non-transitory computer readable medium having recorded thereon one or more programs for execution by a processor for implementing the method of claim 1.

9. A computer system including a processor and a memory having recorded thereon one or more programs for execution by the processor for managing processing of work units using shared resources, the computer system comprising:
a job scheduler for scheduling access to the shared resources for the work units;
an event trap for capturing a resource related allocation event, the event trap being adapted to dynamically adjust an amount of availability associated with each shared resource identified by the resource related allocation event based on a value associated with the resource related allocation event and indicating an amount of resource for the identified shared resource;
wherein the job scheduler allocates resources to the work units using a real time amount of availability of the shared resources in order to maximize a consumption of the shared resources.

10. The system of claim 9, wherein the event trap is provided between a system call interface of the computer system and the work units.

11. The system of claim 9, wherein the event trap is adapted to increment the amount of availability of the identified shared resource by the amount of resource indicated by the value for allocation events defining a resource release.

12. The system of claim 9, wherein the event trap is adapted to decrement the amount of availability of the identified shared resource by the amount of resource indicated by the value for allocation events defining a resource request.

13. The system of claim 9, wherein the shared resources include one or more processors, each having a plurality of processing cores.

14. The system of claim 9, wherein the shared resources include one or more of: multiple processing core of a heterogeneous nature, shared memory hierarchies with components of heterogeneous access characteristics, shared heterogeneous communications channels, and shared external devices.

15. The system of claim 9, wherein the amount of availability for each shared resource is set to a value that represents 100 percent of capacity of the shared resource, upon initialization.

16. The system of claim 9, wherein processing resources allocated for operation of the event trap are negligible compared to an overall system performance.
